(19) United States
(12) Patent Application Publication
(10) Pub. No.: US 2003/0090201 A1
(43) Pub. Date: May 15, 2003

(54) Organic electro-luminescence device

(76) Inventor: Kuan-Chang Peng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/986,845

(22) Filed: Nov. 13, 2001

(51) Int. Cl. H05B 33/04

(52) U.S. Cl. 313/512

(57) ABSTRACT

The present invention provides an organic electro-luminescence (EL) device, comprising: a substrate; a plurality of first electrodes formed on the surface of the substrate; a plurality of divisions of organic layer, formed on the first electrodes and being superimposed perpendicularly upon the first electrodes, the organic layer comprising at least one organic EL layer; a plurality of second electrodes, formed on the organic layer; a plurality of bottom insulating pads, each disposed between the divisions of the organic layer; and a plurality of heat sinks, each disposed on one of the bottom insulating pads. A moisture absorber is provided between each of the bottom insulating pads and each of the heat sinks and a protective layer is provided on the surface of the device, so that there is space formed between the organic layer, the moisture absorber and the heat sink to achieve cooling and dehumidification functions.

### BACKGROUND OF THE INVENTION

1. Field of the Invention

The present invention generally relates to an organic electro-luminescence (to be abbreviated as “EL” hereinafter) device, and more particularly, to an organic EL device having good cooling and dehumidification functions. Such an organic EL device employs a heat sink and a moisture absorber that can effectively dissipate the heat and absorb the moisture to remarkably prolong the lifetime of the device.

2. Description of the Prior Art

In general, the major challenge that the state-of-the-art technology in organic EL displays (also know as OELDs) is facing is that the organic layer of an organic EL device easily reacts with moisture or oxygen to thus form dark spots, which may adversely affect the luminescence efficiency. Therefore, the lifetime of an organic EL device is closely linked to the cooling condition related to the great amount of heat generated during luminescence operation. On the other hand, the second electrode is easily short-circuited to the first electrode due to improper treatment on the boundary during device fabrication. Furthermore, the precision of matrix grid positioning when organic EL devices displaying the three primary colors (red, green and blue) are fabricated also results in another problem in the industry.

In order to overcome the above problems, some companies have developed a number of prior art organic EL displays. For example, in the U.S. Pat. No. 5,952,037, entitled “Organic electroluminscent display panel and method for manufacturing the same”, there is disclosed an organic EL display panel, as shown in FIG. 1 and FIG. 2. The organic EL display panel has a plurality of emitting portions and the method for manufacturing the same comprises the steps of: forming a plurality of first display electrodes 12 on a substrate 10; forming, on the substrate 10 on which the first display electrodes 12 are formed, a first insulating layer by using a first insulating material; forming a second insulating layer by using a second insulating material; etching the second insulating layer through the openings of a photo mask by using a dry-etching or wet-etching, thereby forming a plurality of ramparts 14 and insulating stripes 18 projecting in a direction parallel to the substrate; wherein the insulating stripes 18 are formed on the ramparts 14 and thus overhanging portions 185 are formed since the insulating stripes 18 are wider than the ramparts 14; forming a shadow mask onto top surfaces of the insulating stripes 18, exposing only the overhanging portions 185 and the openings between the overhanging portions 185; forming an organic layer 16 by deposition onto the substrate 10 and the first display electrodes 12, wherein the width of an organic layer 16 is larger than the distance between two overhanging portions 185; forming a plurality of second electrodes 17 by deposition onto the organic layer 16; and finally, forming an protective sealing layer 19 on at least the second display electrodes. In addition, a first reflective layer 22 is further formed on the protective sealing layer 19, so that the light generated can be collected and emitted in the direction towards the substrate 10. However, a second reflective layer 24 can also be formed on the bottom surface of the substrate 10, so as to increase the luminescence efficiency.

Even though this prior art provides an organic EL display panel and method for manufacturing the same, which can prevent a short-circuit between the edge of the first electrode and the second electrode and also improve the precision of matrix grid positioning, however, there are still some problems, related to heat and moisture, left unsolved.

### SUMMARY OF THE INVENTION

Therefore, the present invention has been made to solve such problems in view of the forgoing status. It is the primary object of the present invention to provide an organic EL device having good cooling function to effectively dissipate the heat, so as to remarkably prolong the lifetime of the device.

It is another object of the present invention to provide an organic EL device having good dehumidification functions to effectively absorb the moisture, so as to prevent the generation of undesirable dark spots.

It is still another object of the present invention to provide an organic EL device, in which a second electrode is easily fabricated and has good isolation from a first electrode.

It is yet another object of the present invention to provide an organic EL device, in which the precision of matrix grid positioning when organic EL devices displaying the three primary colors (red, green and blue) are fabricated is improved.

In order to achieve the foregoing objects, the present invention provides an organic EL device, comprising: a substrate; a plurality of first electrodes formed on the surface of said substrate; a plurality of divisions of organic layer, formed on said first electrodes and being superimposed perpendicularly upon said first electrodes, said organic layer comprising at least one organic EL layer; a plurality of second electrodes, formed on said organic layer; a plurality of bottom insulating pads, each disposed on said substrate between said divisions of said organic layer; and a plurality of heat sinks, each disposed on one of said bottom insulating pads.

It is preferable that said organic layer is divided by forming said bottom insulating pads and said heat sinks so that the matrix grids in said device are precisely positioned.

It is preferable that the heat generated during the luminescence of said organic layer is conducted through each of said heat sinks and then dissipated effectively.

It is preferable that a moisture absorber is provided between each of said bottom insulating pads and each of said heat sinks and a protective layer is provided on the surface of said device, so that there is space formed between said organic layer, said moisture absorbers and said heat sinks to achieve cooling and dehumidification functions.

It is preferable that a insulating stripe is formed on each of said heat sinks, wherein the width of said insulating stripe is larger than said heat sink and thus overhanging portions are formed, so that said organic layer is formed by using tilt evaporation to be wider than the distance between two of said overhanging portions and said second electrodes are formed by using vertical evaporation to be electrically isolated from said first electrodes.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a 3D schematic view showing the structure of an organic EL device in accordance with the prior art;

FIG. 2 is an enlarged cross-sectional view showing the structure of the organic EL device of FIG. 1;

FIG. 3A is a cross-sectional view showing the structure of an organic EL device in accordance with one embodiment of the present invention;

FIG. 3B is a vertical schematic view showing the embodiment as shown in FIG. 3A;

FIG. 4A is a 3D schematic view showing the process of the embodiment as shown in FIG. 3A;

FIG. 4B to FIG. 4F are cross-sectional views showing the process of the embodiment along the line 7-7 as shown in FIG. 4A;

FIG. 5 is a cross-sectional view showing the structure of an organic EL device in accordance with another embodiment of the present invention;

FIG. 6 is a cross-sectional view showing the structure of an organic EL device in accordance with still another embodiment of the present invention;

FIG. 7 is a cross-sectional view showing the structure of an organic EL device in accordance with still another embodiment of the present invention;

FIG. 8 is a cross-sectional view showing the structure of an organic EL device in accordance with still another embodiment of the present invention; and

FIG. 9 is a cross-sectional view showing the structure of an organic EL device in accordance with still another embodiment of the present invention.

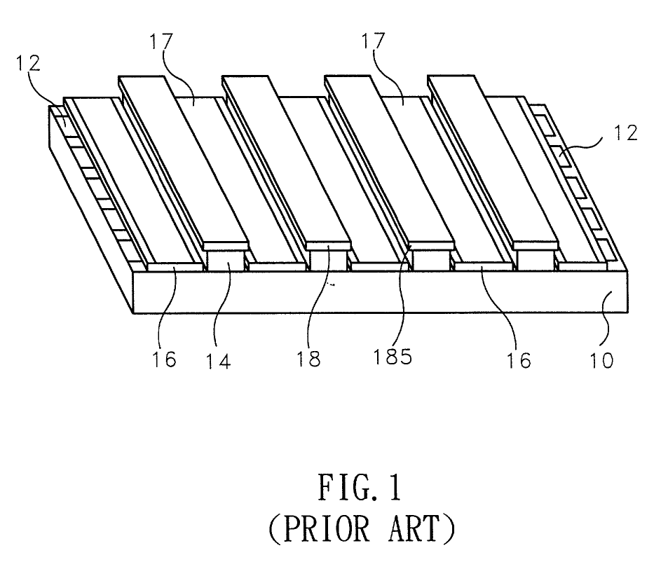

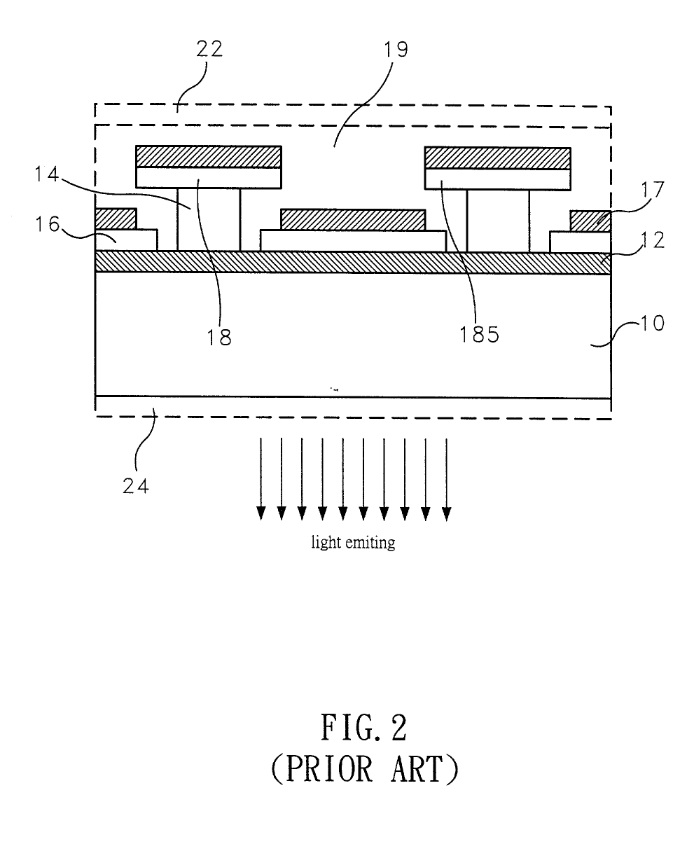

### DETAILED DESCRIPTION OF THE INVENTION

The present invention providing an organic EL device having good cooling and dehumidification functions can be exemplified by the preferred embodiments as described hereinafter.

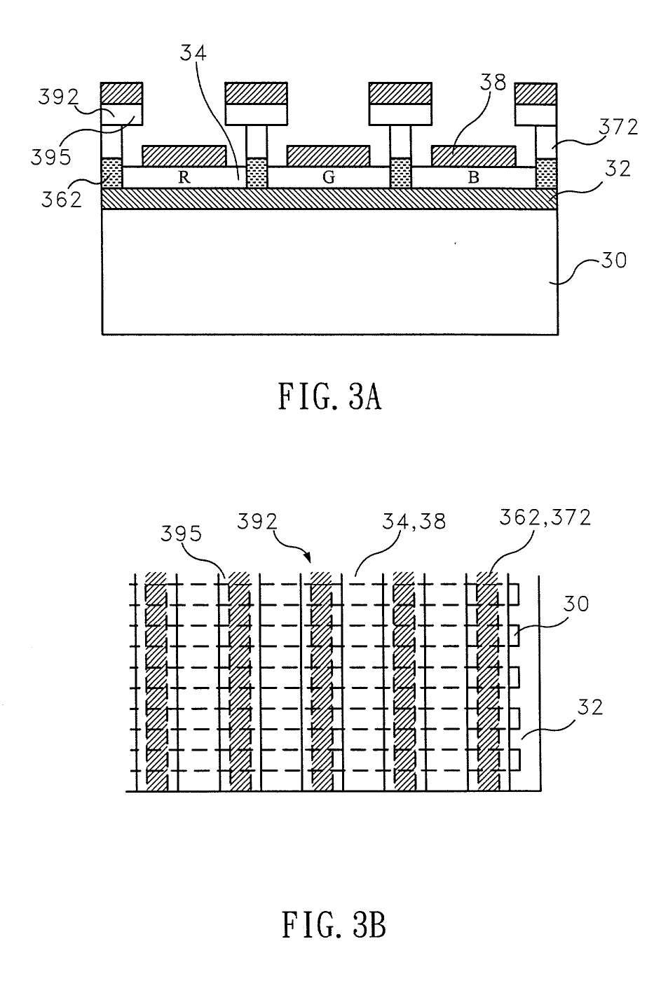

To start with, please refer to FIG. 3A and FIG. 3B, which are a cross-sectional view and a vertical view of the structure of an organic EL device in accordance with one embodiment of the present invention. As shown in the figures, the organic EL device comprises: a substrate 30; a plurality of first electrodes 32; a plurality divisions of organic layer 34; a plurality of second electrodes 38; a plurality of bottom insulating pads 362; and a plurality of heat sinks; wherein the first electrodes 32 are formed on the surface of the substrate 30; the organic layer 34, comprising at least one organic EL layer, is formed on the first electrodes 32 and is superimposed perpendicularly upon the first electrodes 32; a second electrode 38 is formed on each division of the organic layer 34; and the bottom insulating pads 362 are disposed between the divisions of the organic layer 34, so that the organic layer 34 is divided and the matrix grids in the device are precisely positioned; the thickness of the bottom insulating pads 362 is larger than that of the organic layer 34 and a heat sink 372 is disposed on each of the bottom insulating pads 362, so that the heat generated during the luminescence of the organic layer 34 can be conducted through each of the heat sink 372 and then dissipates effectively. Therefore, the temperature during operation is lowered and the lifetime is prolonged. In addition, this can prevents a short circuit between the organic layer 34 and the heat sink 372.

The present invention can also be implemented by using a insulating stripe 392 formed on each of the heat sinks 372, wherein the width of the insulating stripe 392 is larger than the heat sink 372 and thus overhanging portions 395 are formed, so that the organic layer 34 is formed by using tilt evaporation to be wider than the distance between two overhanging portions 395 and the second electrodes 38 are formed by using vertical evaporation to be electrically isolated from the first electrodes 32. The organic layer 34 can be one of a red light emitting organic layer, a green light emitting organic layer, a blue light emitting organic layer and their combination.

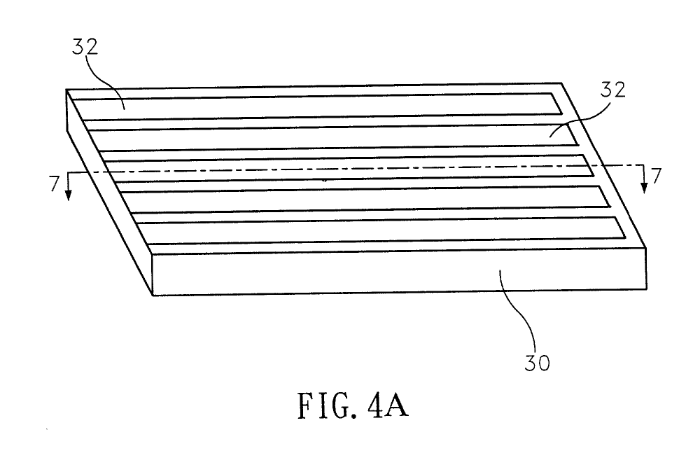

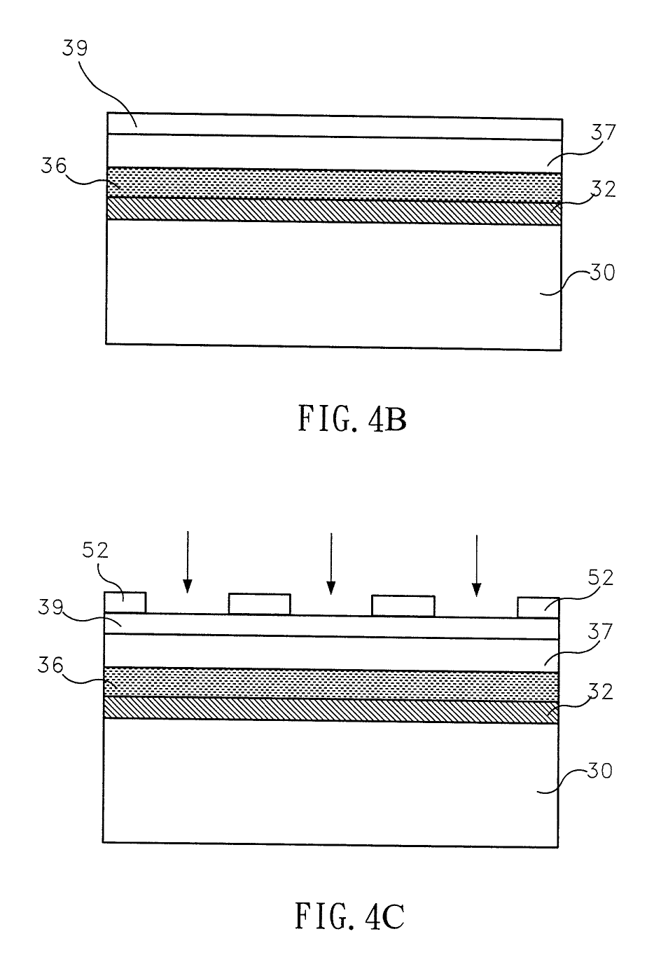

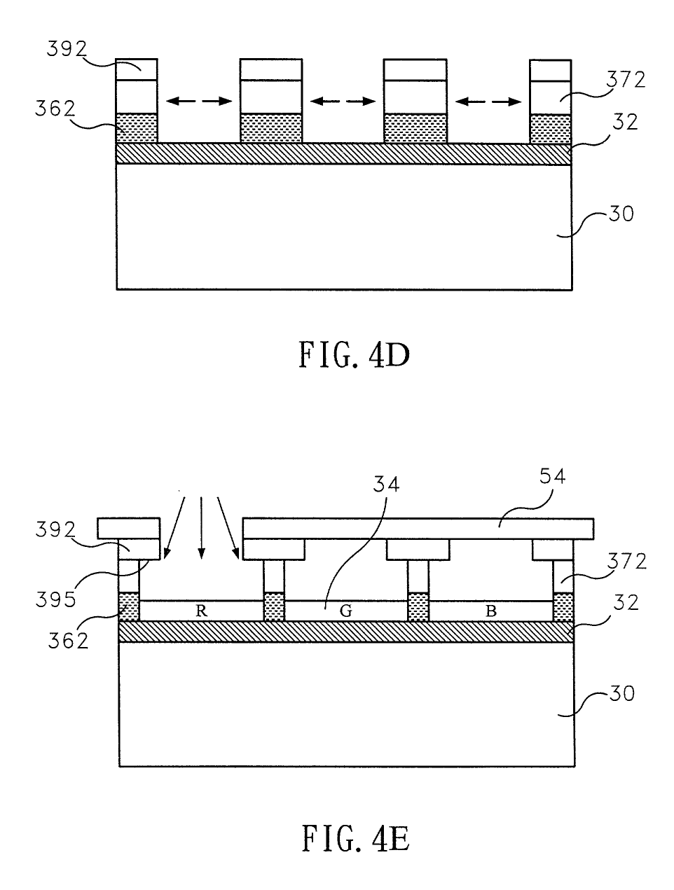

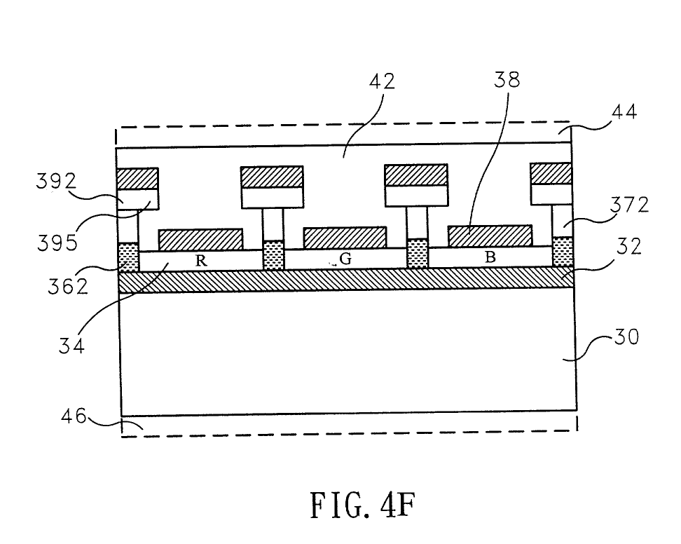

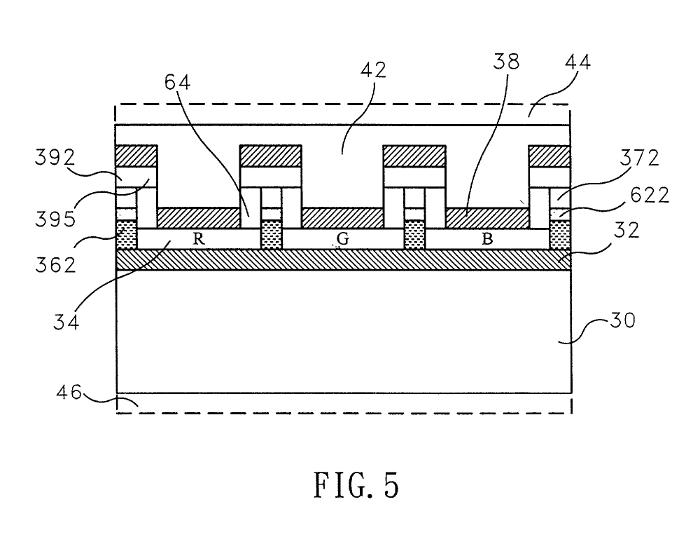

Please refer to FIG. 4A to FIG. 4F, which are schematic views showing the process of the embodiment as shown in FIG. 3A. As shown in the figures, a plurality of first electrodes 32 are formed on the surface of a substrate 30, and each of the first electrodes 32 are in parallel (as shown in FIG. 4A). A bottom insulating layer 36, a heat sink layer 37, and a top insulating layer 39 are formed on the substrate 30 containing the first electrodes 32 (as shown in FIG. 4B). After a mask 52 is formed on the insulating layer 39, the exposed portions of the bottom insulating layer 36, the heat sink layer 37, and the insulating layer 39 are removed by vertical etching, and thus bottom insulating pads 362, heat sinks 372 and top insulating stripes 392 are formed (as shown in FIG. 4C and FIG. 4D). Overhanging portions 395 are formed by laterally etching the heat sinks 372 and the bottom insulating pads 362 (as shown in FIG. 4E). Then, a mask 54 covers the insulating stripes 392, only exposing portions where the light of different colors is to be emitted, and the organic layer is formed by using tilt evaporation on the substrate 30 and the first electrodes 32 (as shown in FIG. 4E). Finally, vertical evaporation is performed through the opening between the overhanging portions 395 of the insulating stripes 392 and thus the second electrodes 38 are formed (as shown in FIG. 4F).

To further protect the organic layer 34 as well as the whole body of the device, a protective layer 42 is provided on the surface of said device moreover. A reflective layer 44 can also be formed on the protective layer 42, so that the light generated from the organic layer 34 can be collected and emitted in the direction towards the substrate 30. However, a second reflective layer 46 can also be formed on the bottom surface of the substrate 30, so as to increase the luminescence efficiency. On the other hand, the bottom insulating pads 362 can be implemented by using an insulating material with moisture absorption function to absorb the moisture unable to eliminate during fabrication process, so that the undesired dark spots can be reduced.

Secondly, please refer to FIG. 5, which is a cross-sectional view showing the structure of an organic EL device in accordance with another embodiment of the present invention. As shown in the figure, the present embodiment is characterized in that moisture absorbers 662 implemented by using a material with moisture absorption function are formed between the bottom insulating pads 362 and the heat sinks 372. The protective layer 46 does not necessarily fill in the device, so that there is space 64 formed between the organic layer 34, the second electrodes 38, the moisture absorbers 622 and the protective layer 46. Therefore, the moisture absorbers 622 absorb, from the organic layer 34 through the space 46, the moisture unable to eliminate during fabrication process. The heat sinks also improve the cooling efficiency with the help from the flowing gas in the space 46. In the present embodiment, the moisture absorbers 622 do not contact the first electrodes 32, the organic layer 34 and the second electrodes 38, therefore, they can be formed by materials with moisture absorption function, regardless of the insulating property. The bottom insulating pads 362 can also be made of general insulating materials. Accordingly, the present embodiment provides a wide range for material selection and ease in fabrication.

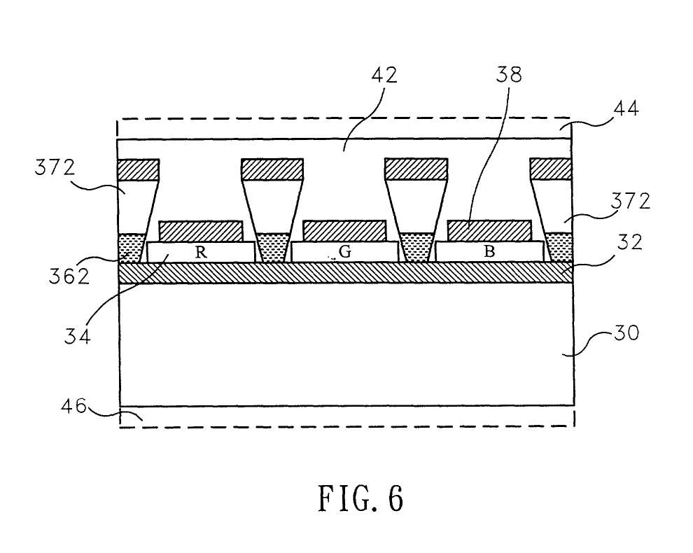

Moreover, please refer to FIG. 6, which is a cross-sectional view showing the structure of an organic EL device in accordance with another embodiment of the present invention. As shown in the figure, the present embodiment is similar to that in FIG. 4F. However, the heat sinks 372 are formed by direct etching into a trapezoid shape, with a wider top side and a narrower bottom side, and function as the overhanging portions 395 in FIG. 4F.

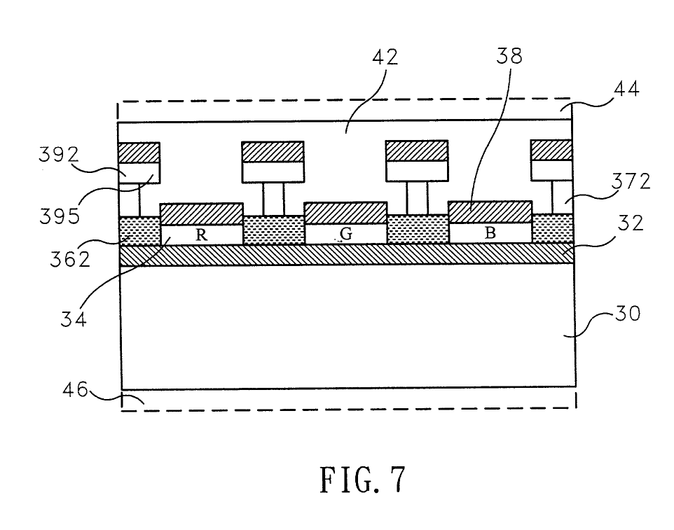

Moreover, please refer to FIG. 7, which is a cross-sectional view showing the structure of an organic EL device in accordance with another embodiment of the present invention. As shown in the figure, the present embodiment is similar to that in FIG. 4F. However, in the present embodiment, only the heat sinks 372 are laterally etched, so that the width of the bottom insulating pads 362 is equal to that of the insulating stripes 392. Therefore, the organic layer 34 and the second electrodes 38 can be formed by vertical evaporation through the openings between the overhanging portions 395, and the thickness of the organic layer 34 is smaller than that of the bottom insulating pads 362. The organic layer 34 is sealed inside the space surrounded by the first electrodes 32, the second electrodes 38 and the bottom insulating pads 362, so as to prevent a short circuit and to achieve cooling function.

Furthermore, according to the embodiment shown in FIG. 6, the heat sinks 372 can be etched to form a trapezoid shape, with a wider top side and a narrower bottom side, so that the width of the bottom insulating pads 362 is equal to that of the top side of the heat sinks 372. The organic layer 34 and the second electrodes 38 can be formed by using vertical deposition so that the thickness of the organic layer 34 is smaller than that of the bottom insulating pads 362. In this way, the first electrodes are isolated from the second electrodes.

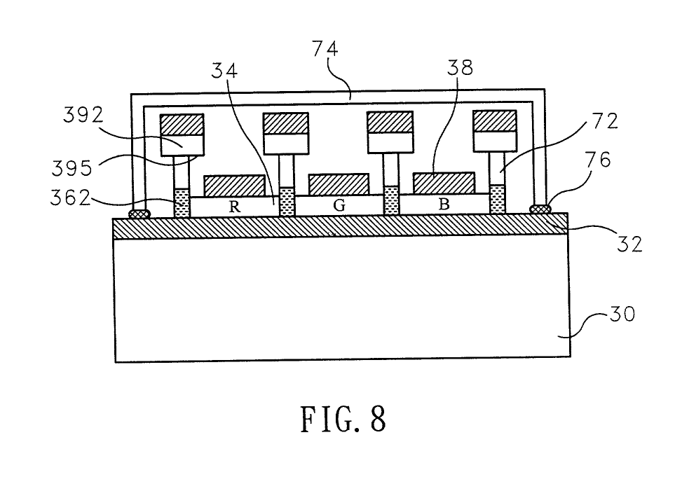

Please refer to FIG. 8, which is a cross-sectional view showing the structure of an organic EL device in accordance with another embodiment of the present invention. As shown in the figure, the present embodiment is similar to that in FIG. 4F. However, in the present embodiment, the heat sinks 372 are replaced with moisture absorbers 72, and a protective case 74 is fixed to the substrate 30 containing the first electrodes 32 by using a sealing glue 76, thereby the device is sealed and protected to prevent the invasion of moisture.

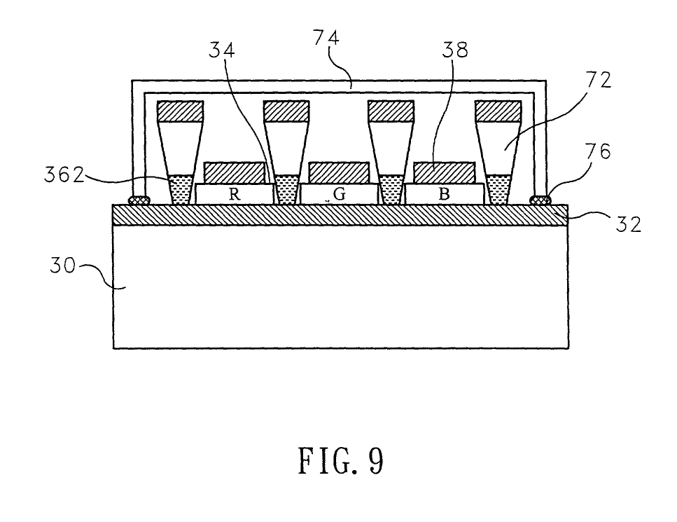

Finally, Please refer to FIG. 9, which is a cross-sectional view showing the structure of an organic EL device in accordance with another embodiment of the present invention. As shown in the figure, the present embodiment is similar to that in FIG. 6. However, in the present embodiment, the heat sinks 372 are replaced with moisture absorbers 72 having a trapezoid shape, with a wider top side and a narrower bottom side. And the protective layer 42 is replaced with a protective case 74 fixed to the substrate 30 containing the first electrodes 32 by using a sealing glue 76.

Certainly, in the above embodiments, the bottom insulating pads can be formed by using insulating materials with moisture absorption function to improve dehumidification.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An organic electro-luminescence (EL) device, comprising:
a substrate;
a plurality of first electrodes formed on the surface of said substrate;
a plurality of divisions of organic layer, formed on said first electrodes and being superimposed perpendicularly upon said first electrodes, said organic layer comprising at least one organic EL layer;
a plurality of second electrodes, formed on said organic layer;
a plurality of bottom insulating pads, each disposed between said divisions of said organic layer; and
a plurality of heat sinks, each disposed on one of said bottom insulating pads.

2. The organic EL device as recited in claim 1, wherein the thickness of said bottom insulating pads is larger than that of said organic layer.

3. The organic EL device as recited in claim 1, wherein a protective layer is provided on the surface of said device.

4. The organic EL device as recited in claim 3, wherein said bottom insulating pads are formed by using an insulating material with moisture absorption function.

5. The organic EL device as recited in claim 1, wherein a insulating stripe is formed on each of said heat sinks, wherein the width of said insulating stripe is larger than said heat sink and thus overhanging portions are formed.

6. The organic EL device as recited in claim 5, wherein the width of said organic layer is larger than the distance between two of said overhanging portions.

7. The organic EL device as recited in claim 6, wherein the width of said second electrodes is smaller than that of said organic layer.

8. The organic EL device as recited in claim 3, wherein a moisture absorber comprising a material with moisture absorption function is provided between each of said bottom insulating pads and each of said heat sinks.

9. The organic EL device as recited in claim 8, wherein there is space formed between said organic layer, said moisture absorber, said second electrode and said protective layer to achieve dehumidification function.

10. The organic EL device as recited in claim 1, wherein said the heat sinks are formed in a trapezoid shape, with a wider top side and a narrower bottom side.

11. The organic EL device as recited in claim 1, wherein said organic layer is one of a red light emitting organic layer, a green light emitting organic layer, a blue light emitting organic layer and their combination.

12. The organic EL device as recited in claim 1, wherein said heat sinks are formed by using a material with high thermal conductivity such as metals.

13. The organic EL device as recited in claim 5, wherein the width of said bottom insulating pads is larger than that of said heat sinks.

14. The organic EL device as recited in claim 13, wherein the width of said organic layer and said second electrode is equal to the distance between two of said bottom insulating pads.

15. The organic EL device as recited in claim 13, wherein the thickness of said organic layer is smaller than that of said bottom insulating pads.

16. The organic EL device as recited in claim 13, wherein said bottom insulating pads comprise an insulating material with moisture absorption function.

17. The organic EL device as recited in claim 10, wherein the width of said bottom insulating pads is larger than that of bottom side of said heat sinks.

18. The organic EL device as recited in claim 17, wherein the width of said organic layer and said second electrode is equal to the distance between two of said bottom insulating pads.

19. The organic EL device as recited in claim 18, wherein said bottom insulating pads comprise an insulating material with moisture absorption function.

20. An organic EL device, comprising:
a substrate;
a plurality of first electrodes formed on the surface of said substrate;
a plurality of divisions of organic layer, formed on said first electrodes and being superimposed perpendicularly upon said first electrodes, said organic layer comprising at least one organic EL layer;
a plurality of second electrodes, formed on said organic layer;
a plurality of bottom insulating pads, each disposed between said divisions of said organic layer;
a plurality of moisture absorbers, each disposed on one of said bottom insulating pads; and
a protective case, for sealing said device.

21. The organic EL device as recited in claim 20, wherein said moisture absorbers are formed in a trapezoid shape, with a wider top side and a narrower bottom side.
